(19) United States
(12) Patent Application Publication
(10) Pub. No.: US 2017/0078880 A1
(43) Pub. Date: Mar. 16, 2017

(54) CLOUD-BASED FRIEND ONBOARDING FOR WI-FI NETWORK COMMUNICATION AUTHENTICATION

(71) Applicant: CloudMondo, Inc., Santa Clara, CA (US)

(72) Inventors: Bojan Likar, Cupertino, CA (US); Ihab Abu-Hakima, Los Altos, CA (US); Sungwook Han, Sunnyvale, CA (US)

(21) Appl. No.: 15/255,734

(22) Filed: Sep. 2, 2016

Related U.S. Application Data
(60) Provisional application No. 62/219,132, filed on Sep. 16, 2015.

(51) Int. Cl. H04W 12/06; H04L 29/06; H04L 29/08; H04W 4/00; H04W 48/18; H04W 48/20

(52) U.S. Cl. CPC H04W 12/06; H04W 48/18; H04W 48/20; H04L 67/306; H04L 67/10; H04L 67/02; H04W 4/008; H04L 63/08; H04L 63/102; H04W 84/12

(57) ABSTRACT

Cloud-based onboarding authenticates potential friends on a network associated with a network owner. Authentication can be an explicit confirmation of friendship with a real-time approval of a request automatically forwarded to the network owner. Authentication can also be an implicit confirmation of friendship can be based on social network accounts. Further, confirmation of friendship can be inferred for automatic access grants.

### CROSS-REFERENCE TO RELATED APPLICATIONS

This application claims the benefit of priority under 35 U.S.C. 119(e) to U.S. Application No. 62/219,132, filed Sep. 16, 2015, entitled CLOUD-BASED FRIEND ONBOARDING FOR WI-FI NETWORK COMMUNICATION AUTHENTICATION, by Bojan LIKAR, et al., the contents of which being hereby incorporated by reference in its entirety.

### FIELD OF THE INVENTION

The invention relates generally to computer networking, and more specifically, to authentication of users for onboarding to a Wi-Fi network.

### BACKGROUND

The mobility of computerized devices through Wi-Fi and other innovations has manifested more demand for mobility in computerized devices. To this end, ubiquitous networking would permit a wireless connection anytime, anywhere, and from any device. Unfortunately, the risk of malicious users and otherwise undesirable users hinders completely open networks. On the other hand, the inconvenience of security authentications, such as Wi-Fi credentials needed to log on to a local network in order to gain Internet access burdens benign users.

For example, when currently visiting the home of a friend, credentials are manually transferred to the friend in order to gain Wi-Fi connectivity. The inconvenience of inputting credentials on a cell phone is made worse by the complex nature of credentials (e.g., use of caps and symbols). Further, an owner of the home needs to recall or find the credentials, and if the owner is not home at the time, it may be impossible to access the Wi-Fi network altogether.

What is needed is a robust technique for cloud-based authentication of trusted users for onboarding to a Wi-Fi or other type of network. In some cases, social networking connections can provide an assumed level of trust for automated onboarding techniques.

### SUMMARY

The shortcomings of the prior art are addressed by methods, (non-transitory) computer program products, and systems for cloud-based authentication of trusted users for onboarding to a data communication network.

In one embodiment, a request for network access is received at a cloud-based onboarding manager responsive to the potential friend requesting access to a Wi-Fi network serviced by an access point. The access request can be sent by the access point or by a mobile application on a device of the potential friend. The cloud-based Wi-Fi onboarding manager identifies a network owner/manager and sends an approval request in real-time to, for example, a mobile application on a smartphone registered to the network owner/manager during a configuration process.

Verification of friendship varies. In an embodiment, an explicit positive response to the approval request can result in an automatically established secure connection to the Wi-Fi network for the device of the potential friend. Credentials for the connection can either be bypassed for the potential friend device from the access point, or credentials can be passed securely to the mobile application of the potential friend device. In another embodiment, an implicit response is determined by confirming relationships on a social network such as Facebook. In one aspect, API messages are sent to compare friend lists and identify any direct connections in order to confirm an implicit friendship. Still other embodiments infer a friendship by other factors, such as geographical location and common friends.

Advantageously, better network access for mobile devices improves performance of the devices, and the usefulness of mobile devices to users.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a system for friend onboarding for Wi-Fi network authentication, according to one embodiment.

FIG. 2 is a more detailed block diagram illustrating a cloud-based Wi-Fi onboarding manager of FIG. 1, according to one embodiment.

FIG. 3 is a sequence diagram illustrating interactions between components of the system in FIG. 1, according to one embodiment.

FIG. 4 is a flow chart illustrating a method for friend onboarding for Wi-Fi network authentication, according to one embodiment.

FIGS. 5A-5B are flow charts illustrating the confirmation step of the method of FIG. 4, as an explicit confirmation of friendship, and an implicit confirmation of friendship, according to some embodiments.

FIG. 6 is a block diagram illustrating an exemplary computing device for implementing the techniques described herein, according to one embodiment.

### DETAILED DESCRIPTION

Methods, (non-transitory) computer program products, and systems for friend onboarding as Wi-Fi network authentication, as described herein.

The described techniques can apply to a homeowner allowing friends quick access to networking when visiting, and under the purview of a Wi-Fi network controlled by the homeowner. Friends, as referred to herein, can take many different forms, aside from the literal form of two social buddies. A friendship between friends can be explicit, in that a network owner confirms the friendship in real-time over a mobile device. A friendship can also be implicit, in that connections are automatically identified on social networks or other commonalities.

Additionally, existing friendships can be direct connections, or less direct. For example, two followers of the same Twitter celebrity can be considered friends. Other forms of friends can include social networking friends, business associates, contacts through an address book, or inferred friends. Even a complete stranger (e.g., guest at a house party), in the literal sense, can be treated as a friend if confirmed by the network owner.

One of ordinary skill in the art will recognize variations to the disclosed embodiments that are contemplated, although no explicitly described. For instance, other type of networking devices bedsides Wi-Fi devices can be configured for friend onboarding (e.g., Bluetooth, audio, NFC, Zigbee or Z-Wave networks rather than or in conjunction with Wi-Fi networks).

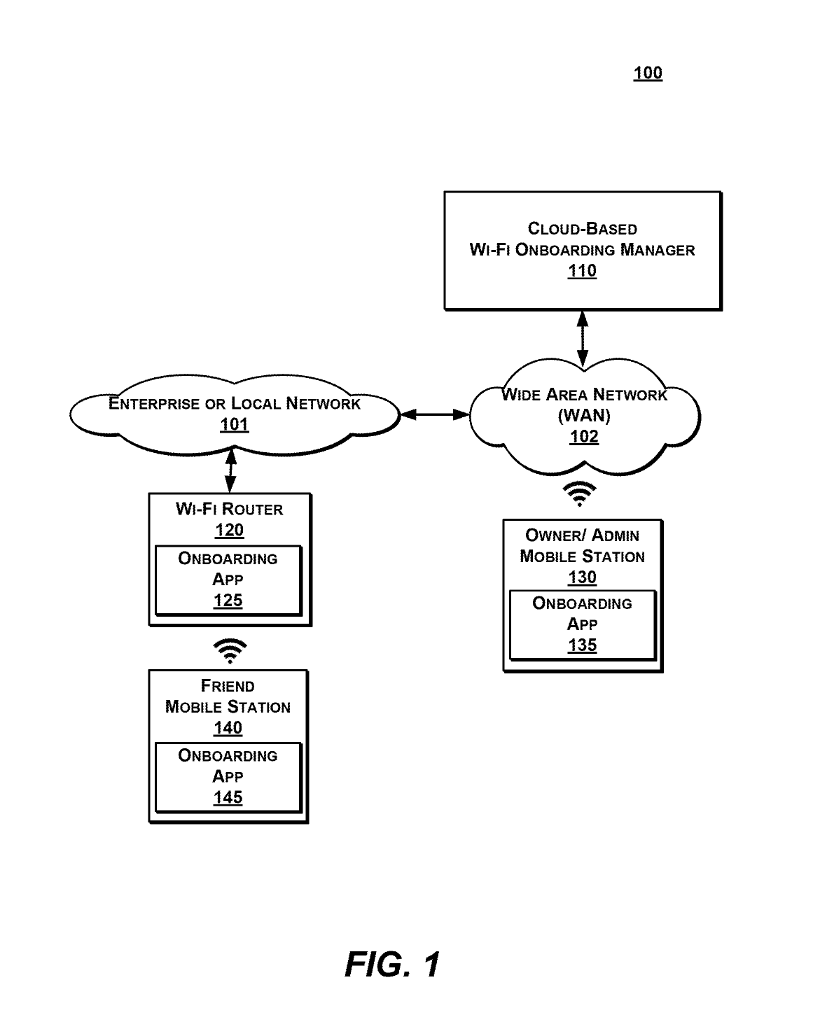

### I. Systems for Friend Onboarding (FIGS. 1-3)

FIG. 1 is a high-level block diagram illustrating a system 100 for friend onboarding for Wi-Fi network authentication, according to one embodiment. The system 100 comprises a cloud-based Wi-Fi onboarding manager 110, a Wi-Fi router 120, an owner (or admin) mobile station 130 and a friend (or associate) mobile station 140. Additional network components can also be part of the system 100, such as firewalls, virus scanners, routers, switches, application servers, databases, as well as additional controllers, access points, access switches, stations, and the like. The network components can be implemented as hardware, software, or a combination of both. The system 100 can be implemented on a home network with a single router, a business with several different physical locations, or at hot spots, for instance.

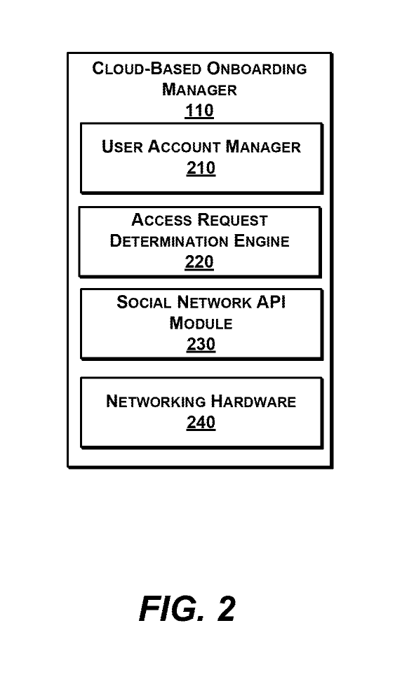

The Wi-Fi router 120 can service the friend mobile station 140 for access to the enterprise network 101 as instructed by the onboarding app 125. The onboarding app 125 determines whether a friendship exists between a network owner and the possible friend, the friend mobile station 140. In a first embodiment, an explicit friendship is determined by receiving real-time verification from a network owner. In a second embodiment, an implicit friendship is determined by identifying a connection through a social network, a contacts list, or by inference. One example of an inferential friendship is based on geographical locations, friends in common, preferences, and other factors. More detailed embodiments of the Wi-Fi router 120 are described below with reference to FIG. 2.

The owner mobile station 130 is shown wirelessly connected to a wide area network (WAN) 102 (e.g., the Internet) which is connected to the enterprise network 101, but can also have a wired connection or connect directly to the enterprise network 101. Finally, the manager 110 can be an external component connected to the WAN 102 for access to the enterprise network 101.

More generally, the networks of the WAN 102 and the enterprise network 101, couple the components of the system 100 in communication for data transfers in the form of frames. Some components are preferably wired to the networks (e.g., cloud-based Wi-Fi onboarding manager 110, and Wi-Fi router 120). The friend mobile station 140 is wireless connects to the Wi-Fi router 120 on a Wi-Fi portion of the system 100. The networks 101, 102 can be a LAN, WAN, the Internet, a cloud-based network, a data network, a cellular network, a hybrid network, or the like.

The manager 110 facilitates configuration beforehand and real-time response to friend onboarding for the system 100, in an embodiment. To do so, the manager 110 can create a user profile for an owner which may include social networking user profile data, preferences and settings. The manager 110 configures the Wi-Fi router 120 according to default settings and/or settings made by the owner. In response to notification of requested access by a mobile station, the manager 110 locates and notifies the owner mobile station 130 for an indication of whether or not to allow access, and in some cases, a level of access. In some embodiments, the manager 110 refers to a set of rules configured by the owner to automatically make determinations. The list of rules can include social networking authentication as described more fully below.

In one embodiment, the manager 110 comprises a standard server device executing software. The manager 110 can be one device, a group of distributed devices, or a virtualized device. The manager 110 can be operated by a service provider to many different owners having user profiles. Alternatively, the manager 110 can be owned by an enterprise and deployed directly on the enterprise network 101.

The Wi-Fi router 120 responds to access requests according to direction from the manager 110. In more detail, the Wi-Fi router 120 uses beacons to advertise one or more SSIDs available to mobile stations desiring access to the WAN 102 or just to the enterprise network 101. Mobile stations such as the friend mobile station 140 associated with the Wi-Fi router 120 using, for example, an open SSID configuration but are not allowed to reach the WAN 102 nor LAN 101. The manager 110 is contacted for authorization. Once the owner has authorized access, the friend mobile station 120 can be transferred to a secure SSID (Service Set Identifier) before and then given Internet access. In one embodiment, an authentication denial by the owner is followed with a standard request for credentials from the Wi-Fi router 120.

In an embodiment, the Wi-Fi router 120 comprises a home networking router by Netgear, Linksys or as provided by an ISP (Internet Service Provider). In another embodiment, the Wi-Fi router 120 comprises a commercial grade access point. In still other embodiments, the mobile stations indirectly connect to the Wi-Fi router 120 and first connect to a repeater or other peripheral device in a mesh network. One implementation of the Wi-Fi router 120 includes an onboarding app 125 to implement processes of the manager 110. To provide network service, in one embodiment, the Wi-Fi router 120 complies with IEEE 802.11 protocols (promulgated by the Institute of Electrical and Electronics Engineers). Under IEEE 802.11, a beacon with one or more BSSIDs is periodically sent to advertise a presence for new connections and maintain current connections. Then the Wi-Fi router 120 listens for packets addressed to associated BSSIDs and ignores packets addressed to unassociated BSSIDs. Furthermore, the Wi-Fi router 120 forwards packets addressed to MAC (Media Access Control) addresses of associated stations.

The owner mobile station 130 is utilized by an owner or a network administrator to configure the manager 110 and provide authorization requests in real-time or otherwise. Specifically, in one embodiment, the owner mobile station sets up a user profile which includes security information necessary to connect mobile stations to the Wi-Fi router 120. When a friend comes within range of the Wi-Fi router 120, a request for authorization can pop up on the owner mobile station 130. In some instances, the owner merely selects yes or no. Identification information concerning the friend can also be provided, for example, through the manager 110 pre-configurations, social networking data, EAP-SIM authentication, or by contacts stored locally. The owner can permit network access, deny network access, or set access limitations (e.g., limited duration, limited data rate or data volume, one-time access, unlimited access, or access under parental controls).

An embodiment of the owner mobile station 130 can be a smartphone (e.g., including iOS or Android operating system), a tablet or phablet device, a laptop device, or the like. The owner mobile station 130 can further comprise an onboarding app 135. Although mobile stations are contemplated for the maximum benefit of the system 100, an owner can also administer the system from a stationary device such as a PC. Furthermore, rather than being remote, an owner can be in the same room as a friend needing Internet access.

The friend mobile station 140 is automatically authorized for access to the WAN 102 when connecting to the Wi-Fi router 120. In some cases, a friend selects a nearby Wi-Fi network to join in order to reach a web page or other external data. The back end authentication process can be invisible to the friend, or a pop up can indicate that external processes are in action. The friend mobile station 140 can comprise a smartphone or other mobile device or stationary device described herein. Also, the friend mobile station 140 can comprise an onboarding app 145.

Generally, with respect to the onboarding apps 125, 135, 145, many variations are possible, such mobile apps, streaming apps, desktop applications, and daemons. Preferably, an app is downloaded and installed to a device and can be updated as needed. The functions can be implemented in software, hardware, or a combination of both. Over time, some functionality may become integrated with operating systems, browsers, other apps, and the like, such that no app is needed or functionality is spread among the app and other software and hardware components. In this case, the onboarding apps 125, 135, 145 are intended to represent a collection of distributed functionality rather than a single physical implementation of functionality.

In one optional embodiment, authentication is automated or enhanced through social networking connections or between owners and friends. For example, if users are friends on Facebook or connected via LinkedIn, as determined by the system 100, network access can be granted without any human interaction. In more detail, an owner and a friend can register with the system using Facebook credentials. Those same credentials are used to determine a friend connection between the parties. Because Facebook friends are assumed by the system to have a threshold level of trust, network security credentials can be provided by the manager 110. In one embodiment, the manager 110 can make a network access request to an owner through social networking APIs (e.g., send a Twitter message or Facebook private message).

Other social networking platforms examples include Google Circles, Instagram, Snapchat, Google Hangouts, Pinterest, Twitter, and the like. Some embodiments can be extended to friends of friends or other indirect associations. Other systems of trust can include Gmail sender or receiver of email, SMS sender or receiver or text messages, local contacts, phone numbers dialed or received, and the like.

FIG. 2 is a more detailed block diagram illustrating the cloud-based Wi-Fi onboarding manager 110 of FIG. 1, according to one embodiment. The cloud-based Wi-Fi onboarding manager 110 of this embodiment includes a user account manager 210, access request determination engine 220, social network API module 230, and networking hardware 240.

The user account manager 210 preconfigures a user policy for friend onboarding. In one embodiment, the user account is accessed through a user interface executing on a browser or an independent application. A network owner can access settings of the account. Although the description refers to a network owner throughout, this is non-limiting as other actors can include a network administrator, a home owner, an Internet customer, a hot spot operator, and the like.

The access request determination engine 220 responds to real-time access requests. If a friendship can be confirmed by the access request determination engine 220, the access request may be granted. On the other hand, the access request may be denied upon failure to confirm any friendship.

The social network API module 230 connects to social networks in order to identify friendships. In one implementation, a user configures a user account with a friend onboarding policy. On the other hand, a friend onboarding policy can be default, dynamically updated, or the like. The onboarding policy can include credentials for specific networks. By presenting the credentials, the social network API 230 can log on to the network and search a friend list to confirm friendships. For example, Facebook friends, Twitter followers, LinkedIn associates, or neighbors can be verified.

The networking hardware 240 can comprise networking interface components such as Wi-Fi radios, Wi-Fi antennae, transceivers, coders and decoders, digital signal processors, and other supporting lower level hardware and processes necessary for communication across channels. The networking hardware 240 can support different variations of IEEE 802.11, including multiple input/multiple output (MIMO) and other techniques.

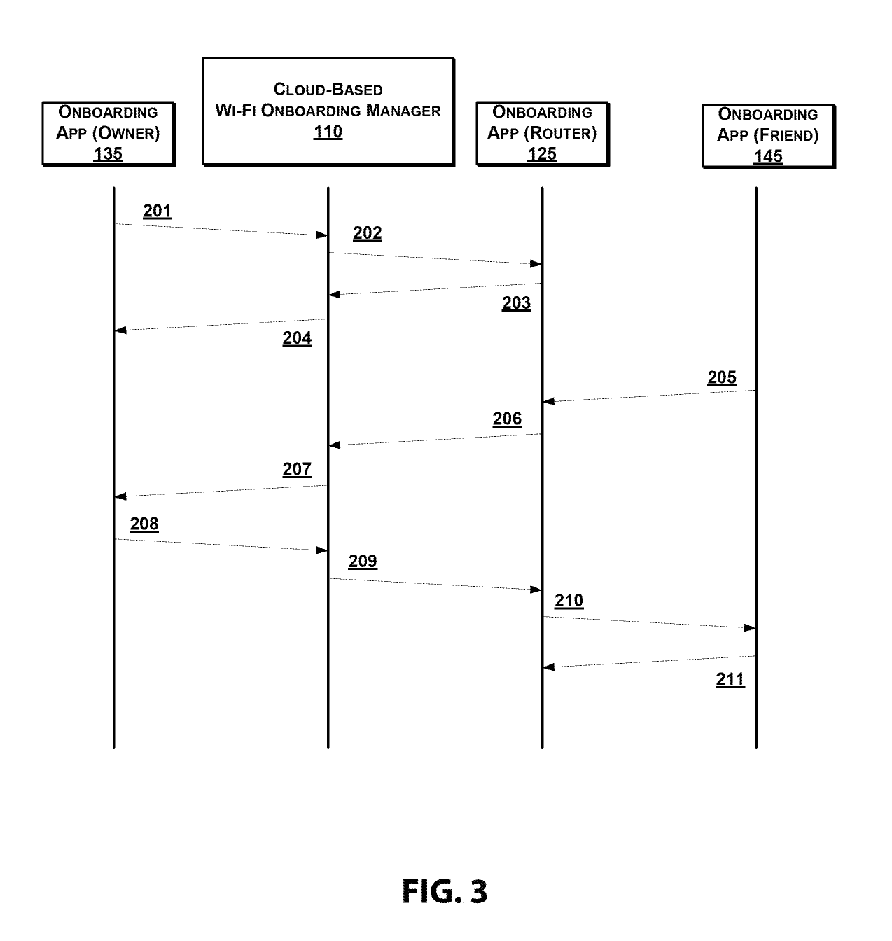

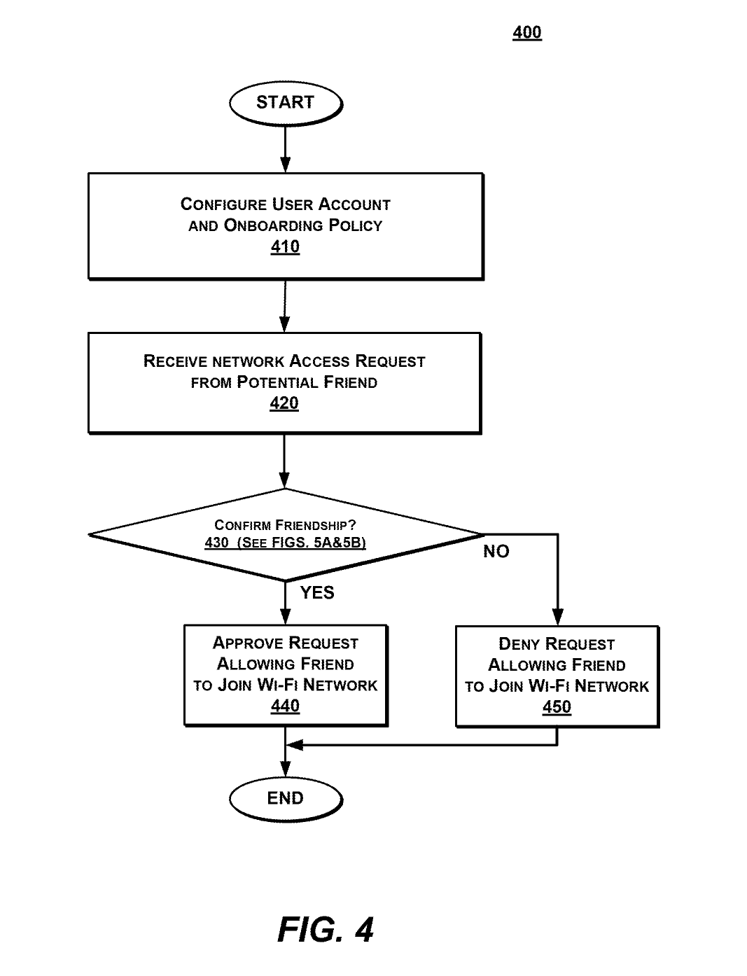

FIG. 3 is a sequence diagram illustrating interactions between components of the system in FIG. 1, according to one embodiment. The specific interactions shown in FIG. 3 and described below can be performed in different orders, can include many sub-interactions, and still be contemplated by the present disclosure. Moreover, the methods below of FIG. 4 describe processes that are internal to the components, as opposed to the external messages exchanged in FIG. 3.

An owner utilizing onboard app 135 at the owner mobile station 130 pre-configures onboarding by registering with the manager 210 (interaction 301) which in turn registers with the onboard app 125 at the Wi-Fi router 130 (interaction 302). Confirmations are returned upstream (interactions 303, 304).

At some later point in time, a friend attempts network access from onboarding app 145 at the friend mobile station 140 (interaction 305). The onboard app 125, in response, checks with the manager 110 (interaction 306) for approval by the owner (interaction 307). The owner response is sent back downstream (interactions 308, 309, 310). If permitted, the friend can then use the Wi-Fi router 120 for network access or to enter credentials. If not permitted, the fried is denied access (interaction 311).

### III. Methods for Friend Onboarding Authentication

FIG. 4 is a block diagram illustrating a method 400 for friend onboarding for Wi-Fi network authentication, according to one embodiment.

A user account is configured in order to establish a friend onboarding policy (step 410). The user account can be secured by username and password credentials. Friend onboarding policies can be established according to various implementations. In one aspect, white lists of individuals that are to be automatically granted access can be designated. In another aspect, credentials for social networking and other types of accounts can be set up to allow communication for confirming friendships. In yet another aspect, factors for inferring programs can be set. Factors can be set according to a sensitivity of a data network such that a business LAN would be configured much stricter than a home LAN without much confidential data.

An access request is received from a potential friend (step 420). The request can be triggered by, for example, a friend visiting another friend's home and needing network access. An onboarding app can detect Wi-Fi networks that are compatible for friend onboarding, and automatically check to see whether a device user qualifies as a friend. In another example, the friend actively requests to join a network that is discovered through beacon broadcasts. The onboarding app can intercept a call through an operating system of the user device, the call indicative of seeking access to a Wi-Fi network.

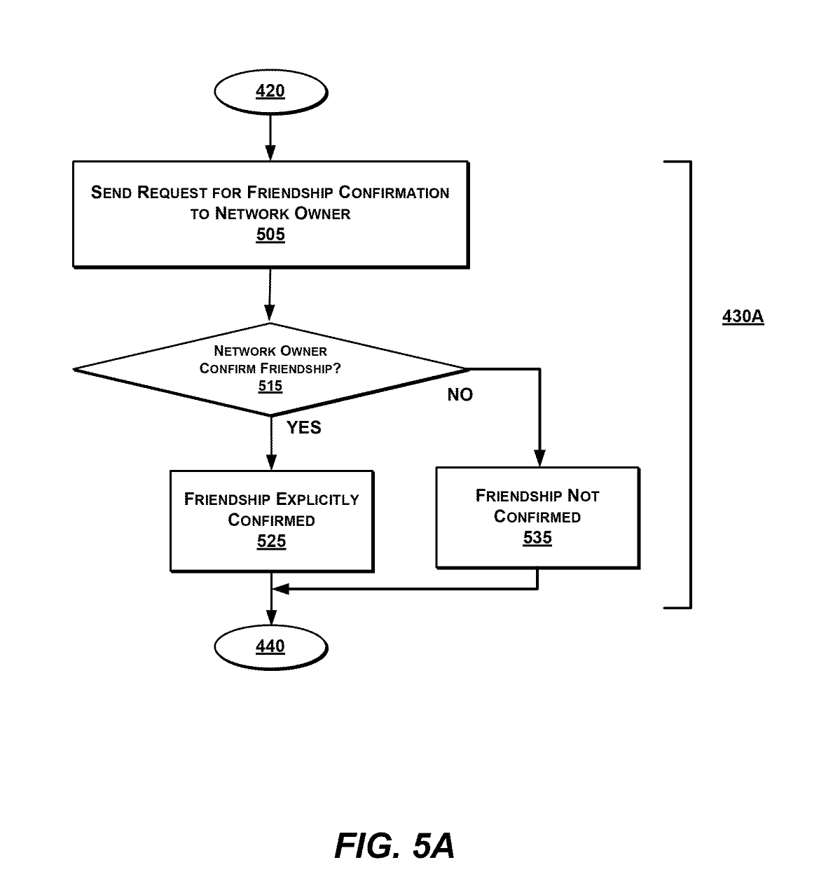

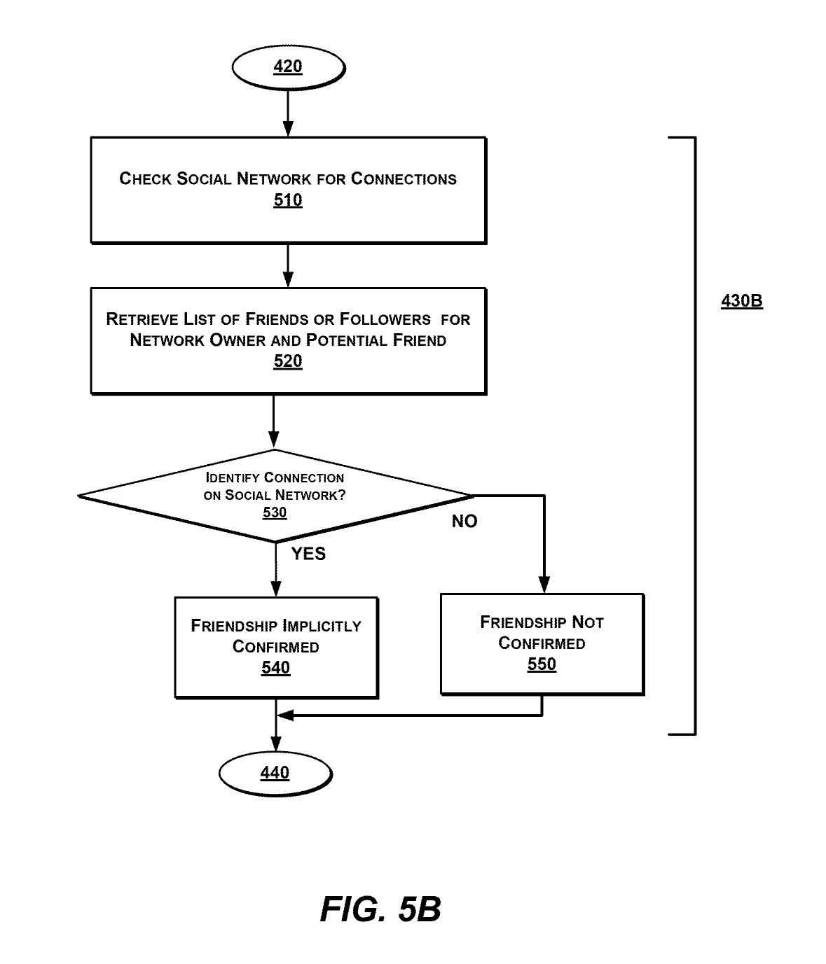

In response, the local onboarding app can notify an external authorization server in order to see if a friendship can be confirmed. Several examples of confirming a friendship (step 430) are set forth in FIGS. 5A and 5B below. In one case, implicit confirmation is a back-up to not receiving any response to an explicit request. Responsive to the potential friend having a friendship confirmed (step 430), authenticating the potential friend as a friend and allowing Wi-Fi network access (step 440). On the other hand, if no friendship is confirmed (step 450), Wi-Fi network access can be denied. In other cases, a quality of service is not as high for unauthenticated friends, although guest access to the Wi-Fi network is permitted. Many different friend onboarding policies and preferences are possible.

FIG. 5A illustrates an explicit friendship confirmation while FIG. 5B illustrates an implicit friendship confirmation, according to some embodiments.

Turning to the explicit confirmation, a friendship verification request is sent to a network owner (step 505). If the network owner approves the request (step 515), the potential friend status is updated to confirmed friend (sometimes referred to simply as “friend” herein) (step 525). If a direct friendship is not confirmed (step 535), access is denied.

Meanwhile, the implicit confirmation checks connections on social networks or other networks, by for example, logging on to user accounts of a social network using APIs (step 510). Pre-configured credentials can be used to automatically request a list of friends for broth the network owner and the potential friend (step 520), for comparison. When credentials are not available, a publicly available list of followers or friends can be extracted. If the network owner and potential friends are friends on Facebook or other social networks (step 530), a direct relationship is identified, friendship is confirmed (step 540). One social network may be enough for confirmation, or more than one can be required by an implementation. In one case, an inference engine can infer a friendship by common friends, common interests, common memberships, or the like. If an implied friendship is not confirmed (step 550), access is denied. The specific factors and algorithm can be implementation-specific.

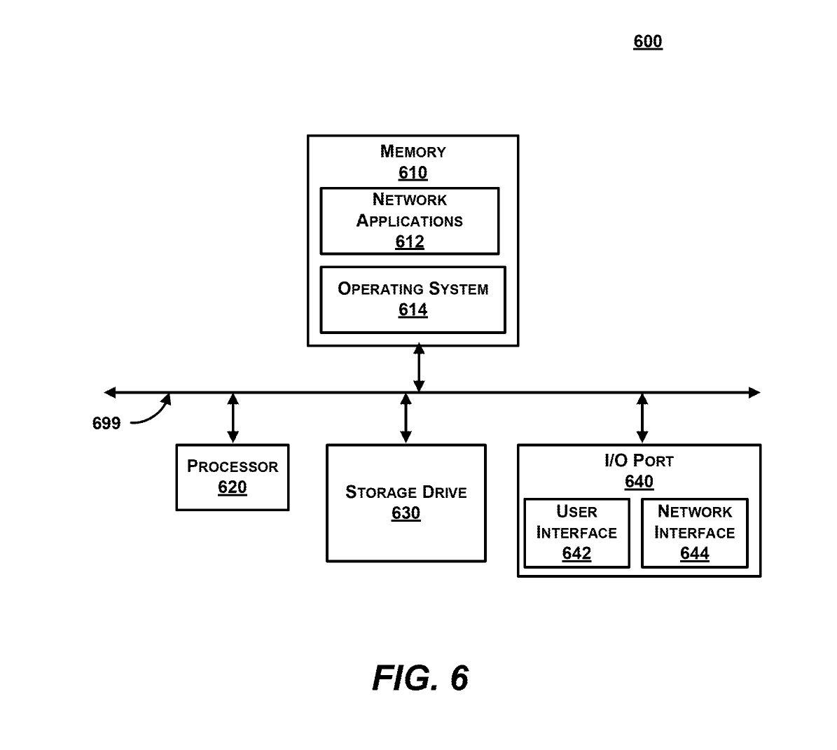

### IV. Generic Computing Device (FIG. 6)

FIG. 6 is a block diagram illustrating an exemplary computing device 600 for use in the system 100 of FIG. 1, according to one embodiment. The computing device 600 is an exemplary device that is implementable for each of the components of the system 100, including the cloud control element 110, the access points 121A,B, 131, and the station 140. The computing device 600 can be a mobile computing device, a laptop device, a smartphone, a tablet device, a phablet device, a video game console, a personal computing device, a stationary computing device, a server blade, an Internet appliance, a virtual computing device, a distributed computing device, a cloud-based computing device, or any appropriate processor-driven device.

The computing device 600, of the present embodiment, includes a memory 610, a processor 620, a storage drive 630, and an I/O port 640. Each of the components is coupled for electronic communication via a bus 699. Communication can be digital and/or analog, and use any suitable protocol.

The memory 610 further comprises network applications 612 and an operating system 614. The network applications 612 can include the modules of the components illustrated in FIG. 1. Other network applications 612 can include a web browser, a mobile application, an application that uses networking, a remote application executing locally, a network protocol application, a network management application, a network routing application, or the like.

The operating system 614 can be one of the Microsoft Windows® family of operating systems (e.g., Windows 95, 98, Me, Windows NT, Windows 2000, Windows XP, Windows XP x64 Edition, Windows Vista, Windows CE, Windows Mobile, Windows 8 or Windows 10), Linux, HP-UX, UNIX, Sun OS, Solaris, Mac OS X, Alpha OS, AIX, IRIX32, or IRIX64. Other operating systems may be used. Microsoft Windows is a trademark of Microsoft Corporation.

The processor 620 can be a network processor (e.g., optimized for IEEE 802.11), a general purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the storage drive 630.

The storage drive 630 can be any non-volatile type of storage such as a magnetic disc, EEPROM, Flash, or the like. The storage drive 630 stores code and data for applications.

The I/O port 640 further comprises a user interface 642 and a network interface 644. The user interface 642 can output to a display device and receive input from, for example, a keyboard. The network interface 644 (e.g. RF antennae) connects to a medium such as Ethernet or Wi-Fi for data input and output.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

### IV. Additional Embodiments

Generally, one of ordinary skill in the art will recognize that the examples set forth herein are non-limiting and only illustrative of widely-applicable principles. Accordingly, this description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

We claim:

1. A computer-implemented method in a cloud-based Wi-Fi onboarding server of a data communication system, implemented at least partially in hardware, the method comprising the steps of:
receiving a request for network access from a device associated with a potential friend, at a network interface of the onboarding server, responsive to the potential friend requesting access for a wireless station to receive network service from an access point of the data communication system, the access point providing Wi-Fi access to the data communication system;
identifying a contact for the access point from a user profile of a plurality of user profiles that correlate network devices with specific contacts;
sending an approval request to the contact for explicit confirmation of friendship that allows access to Wi-Fi services of the access point by the potential friend device;
receiving a response to the approval request from the contact; and
responsive to receiving an approval for the approval request, sending instructions allowing automatic configuration of the potential friend device to receive Wi-Fi services from the access point.

2. The method of claim 1, further comprising:
responsive to not receiving a response from the contact, determining whether an implicit friendship with the potential friend can be automatically confirmed; and
responsive to confirming the implicit friendship, sending an approval responsive to the approval request.

3. The method of claim 2, wherein the implicit friendship is automatically confirmed by identifying a preexisting connection on a social network external to the onboarding server.

4. The method of claim 1, further comprising:
responsive to not receiving a response from the contact, the access point allows limited access relative to when an approval is received.

5. The method of claim 1, further comprising:
determining whether an implicit friendship with the potential friend can be automatically confirmed,
wherein sending the approval request comprises sending an indication of the implicit friendship.

6. The method of claim 1, wherein receiving the request for network access comprises receiving from the access point the request for network access.

7. The method of claim 1, wherein receiving the request for network access comprises receiving from an application on the potential friend device the request for network access.

8. The method of claim 1, wherein sending instructions allowing automatic configuration of the potential friend device comprises sending credentials to the potential friend device, independent of the access point, which are automatically passed to the access point.

9. The method of claim 1, wherein sending instructions allowing automatic configuration of the potential friend device comprises sending instructions to the access point to allow the connection without requiring credentials.

10. The method of claim 1, wherein the access point has a wired connection to a wide area network of the data communication system.

11. The method of claim 1, further comprising registering the access point with the user profile of the onboarding server prior to receiving the request.

12. A non-transitory computer program product storing source code that, when executed by a processor, performs a computer-implemented method in a cloud-based Wi-Fi onboarding server of a data communication system, implemented at least partially in hardware, the method comprising the steps of:
receiving a request for network access from a device associated with a potential friend, at a network interface of the onboarding server, responsive to the potential friend requesting access for a wireless station to receive network service from an access point of the data communication system;
identifying a contact for the access point from a plurality of user profiles that correlate network devices with specific contacts;
sending an approval request to the contact for explicit confirmation of friendship that allows access to the access point by the potential friend device;
receiving a response to the approval request from the contact; and
responsive to receiving an approval for the approval request, sending instructions allowing automatic configuration of the potential friend device to be serviced by the access point.
